(19) United States
(12) Patent Application Publication
(10) Pub. No.: US 2025/0321726 A1
(43) Pub. Date: Oct. 16, 2025

(54) PATCHING ORCHESTRATION MANAGEMENT USING VERIFICATION OF IDENTIFIED SERVERS

(71) Applicant: Dell Products L.P., Round Rock, TX (US)

(72) Inventors: Vinicius da Rosa Silva, Recife (BR); Andrei Souza Valins, Porto Alegre (BR); Davis Maino Pinheiro, Canoas (BR); Joao Vitor Knipphoff da Cruz, Santa Cruz do Sul (BR); Stefan Mathias Cavalcanti de Albuquerque, Porto Alegre (BR)

(21) Appl. No.: 18/634,215

(22) Filed: Apr. 12, 2024

(51) Int. Cl. G06F 8/65

(52) U.S. Cl. CPC G06F 8/65

(57) ABSTRACT

Techniques are provided for patching orchestration management using verification of identified servers. One method includes evaluating data sources characterizing deployed servers of an organization to identify a first set of servers of the organization; identifying a second set of servers processed during prior executions of a patching orchestration management process; comparing the first and second sets of servers to generate an updated set of servers; verifying the servers in the updated set of servers using designated server verification criteria; and initiating an automated action based on a result of the verifying. Monitoring software programs may be automatically installed in the servers in the updated set of servers, and in response to a rebooting of a given server, following a patching of the given server, the monitoring software programs installed in the given server provide data from an operation of the given server.

### BACKGROUND

Servers are often patched to update operating systems, applications, libraries or other software. In a large organization, a patching process can be complex and may consume a significant amount of time and/or resources.

### SUMMARY

Illustrative embodiments of the disclosure provide techniques for patching orchestration management using verification of identified servers. One method includes evaluating one or more data sources of an organization to identify a first set of servers of the organization, wherein the one or more data sources store information characterizing one or more deployed servers of the organization; identifying a second set of servers processed during one or more executions, prior to the evaluating, of a patching orchestration management process, wherein the patching orchestration management process is executed by at least one processing device; comparing, by the at least one processing device, the first set of servers and the second set of servers to generate an updated set of servers, wherein the first set of servers and the second set of servers are distinct from one another; verifying one or more servers in the updated set of servers using one or more designated server verification criteria; and initiating at least one automated action based at least in part on a result of the verifying.

Illustrative embodiments can provide significant advantages relative to conventional techniques. For example, technical problems related to such conventional techniques are mitigated in one or more embodiments by implementing patching orchestration management techniques that automatically identify a set of servers to be prepared for a patching process and evaluate the set of servers using one or more designated server verification criteria.

These and other illustrative embodiments described herein include, without limitation, methods, apparatus, systems, and computer program products comprising processor-readable storage media.

### BRIEF DESCRIPTION OF THE DRAWINGS

FIG. 1 illustrates a network computing environment that can be configured for patching orchestration management using verification of identified servers in accordance with an illustrative embodiment;

FIG. 2 illustrates a server setup management module of FIG. 1 in further detail in accordance with an illustrative embodiment;

FIG. 3 is a flow diagram illustrating an exemplary implementation of a patching orchestration management process in accordance with an illustrative embodiment;

FIG. 4 is a flow diagram illustrating an exemplary implementation of a new server discovery process in accordance with an illustrative embodiment;

FIG. 5 is a flow diagram illustrating an exemplary implementation of a server classification process in accordance with an illustrative embodiment;

FIG. 6 is a flow diagram illustrating an exemplary implementation of a server script installation process in accordance with an illustrative embodiment;

FIG. 7 is a flow diagram illustrating an exemplary implementation of a server script execution process in accordance with an illustrative embodiment;

FIG. 8 is a flow diagram illustrating an exemplary implementation of a server health evaluation process in accordance with an illustrative embodiment;

FIG. 9 is a flow diagram illustrating an exemplary implementation of a patch task execution process in accordance with an illustrative embodiment;

FIG. 10 is a sample table illustrating a server change history in accordance with an illustrative embodiment;

FIG. 11 is a sample table illustrating a process events history in accordance with an illustrative embodiment;

FIG. 12 is a flow diagram illustrating an exemplary implementation of a method for patching orchestration management using verification of identified servers, according to one or more embodiments of the disclosure;

FIG. 13 illustrates an exemplary processing platform that may be used to implement at least a portion of one or more embodiments of the disclosure comprising a cloud infrastructure; and

FIG. 14 illustrates another exemplary processing platform that may be used to implement at least a portion of one or more embodiments of the disclosure.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

In one or more embodiments, patching orchestration management techniques are provided that automate the process of patch management. The disclosed patching orchestration management techniques, in at least some embodiments, employ multiple asynchronous phases with a dynamic approach to patch preparation scheduling. The servers to be patched (e.g., application servers and/or database servers) are discovered, classified and labeled, with a corpus of knowledge of categories and attributes, for example, through which the servers can be analyzed. The term “patching orchestration management,” as used herein, is intended to be broadly construed to encompass one or more tasks performed to prepare servers (e.g., servers of an organization) for a patching process, as would be apparent to a person of ordinary skill in the art.

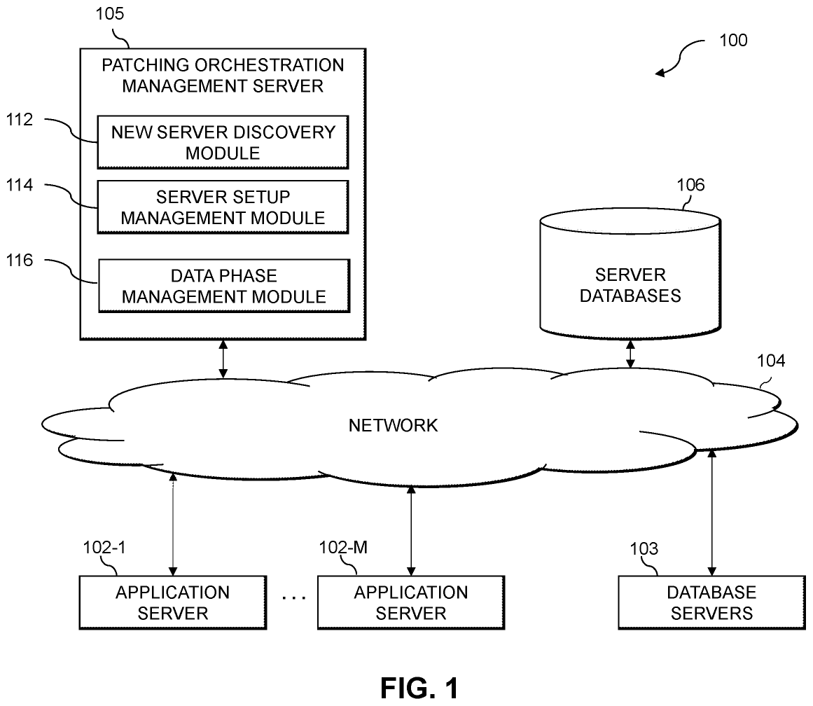

FIG. 1 shows a computer network (also referred to herein as an information processing system) 100 configured in accordance with an illustrative embodiment. The computer network 100 comprises a plurality of application servers 102-1, . . . 102-M, collectively referred to herein as application servers 102 and one or more database servers 103. The application servers 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. A patching orchestration management server 105 is also coupled to network 104.

The application servers 102 may comprise, for example, application servers and/or portions of one or more server systems. The database servers 103 may comprise, for example, database servers and/or portions of one or more server systems. Such devices are examples of what are more generally referred to herein as “processing devices.” Some of these processing devices are also generally referred to herein as “computers.” The application servers 102 and/or database servers 103 may be implemented using virtual and/or physical machines. The application servers 102 and/or database servers 103 in some embodiments comprise respective servers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the one or more database servers 103 can have at least one associated server database 106 configured to store data pertaining to, for example, patching information, configuration information and/or execution logs associated with one or more servers. An example server database 106, such as depicted in the present embodiment, can be implemented using one or more storage systems associated with the one or more application servers 102 and/or the one or more database servers 103. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the one or more application servers 102, the one or more database servers 103 and/or the patching orchestration management server 105 are one or more input-output devices, which illustratively comprise keyboards, displays or other types of input-output devices in any combination. Such input-output devices can be used, for example, to support one or more user interfaces to the one or more application servers 102 and/or the patching orchestration management server 105, as well as to support communication between the one or more application servers 102 and/or the patching orchestration management server 105 and other related systems and devices not explicitly shown.

Additionally, the one or more application servers 102, the one or more database servers 103 and the patching orchestration management server 105 in the FIG. 1 embodiment are each assumed to be implemented using at least one processing device. Each such processing device generally comprises at least one processor and an associated memory, and implements one or more functional modules for controlling certain features of the one or more application servers 102 and/or the patching orchestration management server 105.

More particularly, the one or more application servers 102, the one or more database servers 103 and/or the patching orchestration management server 105 in this embodiment can each comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interfaces allow communication between the one or more application servers 102 and the patching orchestration management server 105, and each illustratively comprises one or more conventional transceivers.

One or more aspects of the disclosure recognize that servers, such as virtual machine-based application servers and/or database servers, often need to be updated for a variety of reasons, such as to address security concerns related to an operating system, to mitigate one or more software bugs and/or to ensure that the servers comply with standards and/or compliance metrics of an organization.

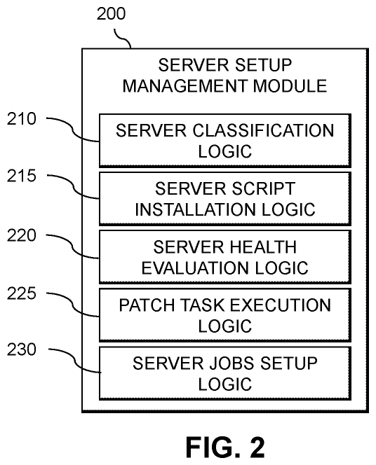

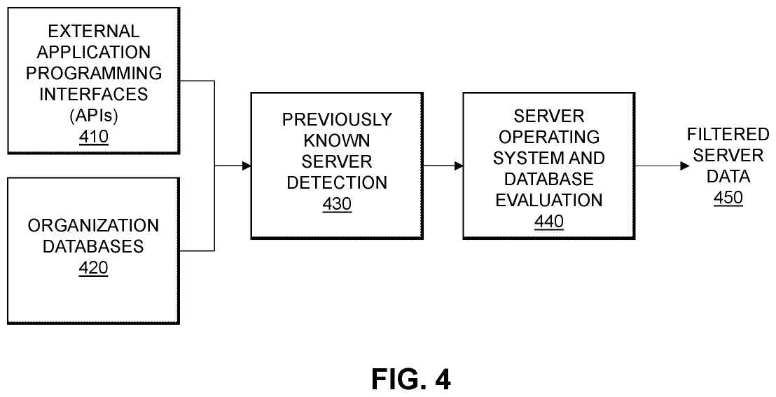

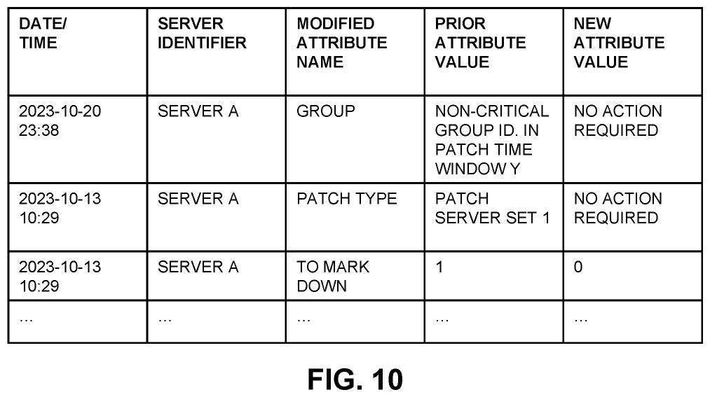

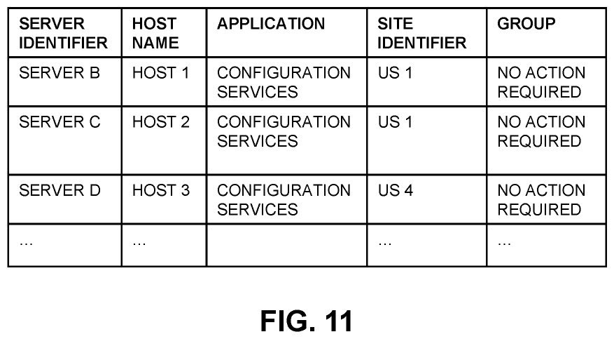

In the FIG. 1 embodiment, the patching orchestration management server 105 comprises a new server discovery module 112, a server setup management module 114 and a data phase management module 116. In at least some embodiments, the new server discovery module 112 implements a server discovery process to identify new servers that need to be prepared for a patching process, as discussed further below in conjunction with FIG. 4. The server setup management module 114 classifies and prepares the identified servers for the patching process, as discussed further below in conjunction with FIGS. 2 and 5 through 9, for example. The data phase management module 116 processes and presents the information collected by the patching orchestration management processes, as discussed further below in conjunction with FIGS. 10 and 11.

It is to be appreciated that this particular arrangement of elements 112, 114 and 116 illustrated in the patching orchestration management server 105 of the FIG. 1 embodiment is presented by way of example only, and alternative arrangements can be used in other embodiments. For example, the functionality associated with the elements 112, 114 and 116 in other embodiments can be combined into a single element, or separated across a larger number of elements. As another example, multiple distinct processors can be used to implement different ones of the elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for the one or more patching orchestration management servers 105 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the one or more application servers 102 and server databases 106 can be on and/or part of the same processing platform.

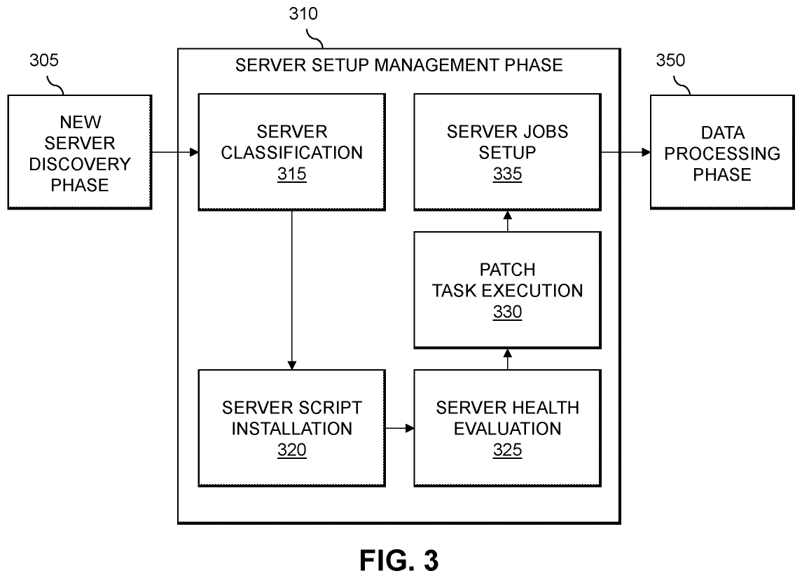

An exemplary process utilizing elements 112, 114 and 116 of an example patching orchestration management server 105 in computer network 100 will be described in more detail with reference to, for example, the flow diagrams of FIGS. 3 through 9.

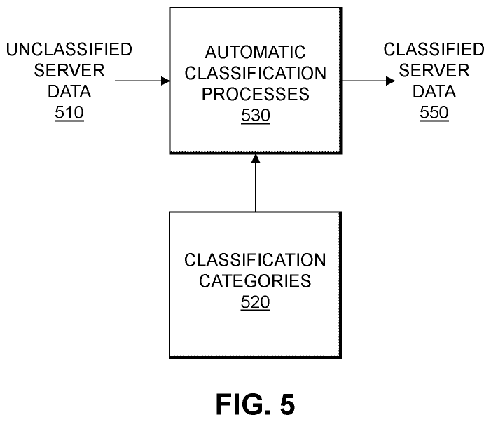

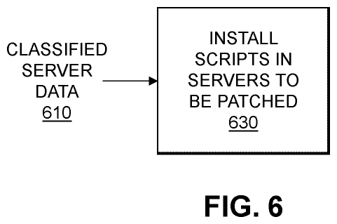

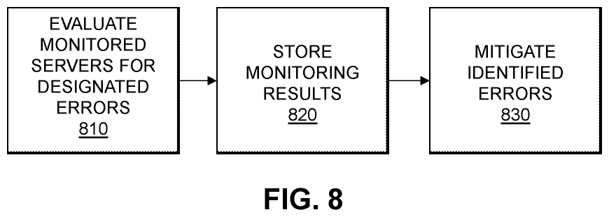

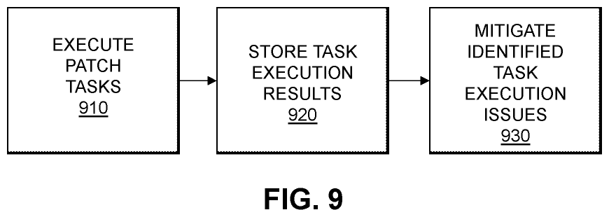

FIG. 2 illustrates a server setup management module 200 in further detail in accordance with an illustrative embodiment. In the example of FIG. 2, the server setup management module 200 comprises server classification logic 210, server script installation logic 215, server health evaluation logic 220, patch task execution logic 225 and server jobs setup logic 230. In at least some embodiments, the server classification logic 210 implements a server classification process to classify identified servers that need to be prepared for a patching process, as discussed further below in conjunction with FIG. 5. The server script installation logic 215 may implement a server script installation process to install one or more scripts on identified servers that need to be prepared for a patching process, as discussed further below in conjunction with FIG. 6. The server health evaluation logic 220 may implement a server health evaluation process that evaluates a health status of identified servers that need to be prepared for a patching process, as discussed further below in conjunction with FIG. 8. A patch task execution logic 225 may implement a patch task execution process on identified servers that need to be prepared for a patching process, as discussed further below in conjunction with FIG. 9. The server jobs setup logic 230 may setup and schedule one or more scripts that will be executed during the patching process.

It is to be appreciated that this particular arrangement of elements 210, 215, 220, 225 and 230 illustrated in the server setup management module 200 of the FIG. 2 embodiment is presented by way of example only, and alternative arrangements can be used in other embodiments. For example, the functionality associated with the elements 210, 215, 220, 225 and 230 in other embodiments can be combined into a single element, or separated across a larger number of elements. As another example, multiple distinct processors can be used to implement different ones of the elements 210, 215, 220, 225 and 230 or portions thereof.

At least portions of elements 210, 215, 220, 225 and 230 may be implemented at least in part in the form of software that is stored in memory and executed by a processor.

It is to be understood that the particular set of elements shown in FIG. 2 for the server setup management module 200 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of elements of the server setup management module 200 can be on and/or part of the same processing platform.

An exemplary process utilizing elements 210, 215, 220, 225 and 230 of an example server setup management module 200 will be described in more detail with reference to, for example, the flow diagrams of FIGS. 3 through 9.

FIG. 3 is a flow diagram illustrating an exemplary implementation of a patching orchestration management process in accordance with an illustrative embodiment. In the example of FIG. 3, a patching orchestration management process is initiated using a new server discovery phase 305 where new servers that should be tracked and monitored by a patching process are identified and the information associated with such servers is obtained and verified using multiple data sources. In this manner, new servers are discovered from various data sources and automatically filtered to define resources suitable for patching orchestration management.

In at least some embodiments, a server setup management phase 310 comprises a server classification process 315, a server script installation process 320, a server health evaluation process 325, a patch task execution process 330 and a server jobs setup process 335. The server classification process 315 classifies identified servers with different values, internal criteria and categories, as discussed further below in conjunction with FIG. 5. By classifying servers into one or more groups and/or categories using server events in a “timeframe” and using server characteristics and behavior within a plurality of processes, the server classification process 315 can manage and organize the patching orchestration management process in a much more in-depth, effective and organized manner, resulting in better results and more informative data.

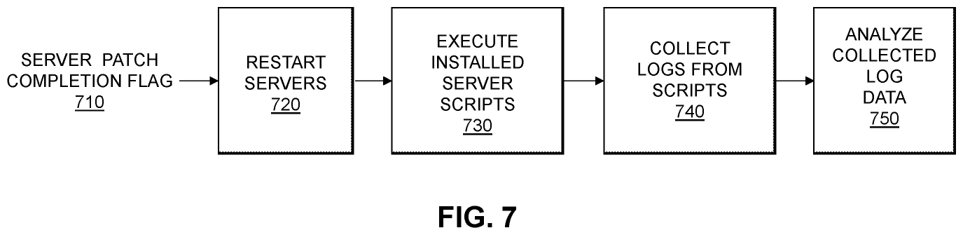

The server script installation process 320 may install one or more software scripts in one or more of the identified servers, as discussed further below in conjunction with FIG. 6. The installed scripts are executed during the patching process to collect logs (e.g., relevant to the patching orchestration itself) following a reboot of one or more of the servers, as discussed further below in conjunction with FIG. 7. The server health evaluation process 325 analyzes one or more of the identified servers, categorizes the identified servers into one or more different error groups that can cause problems during the patching processes and performs one or more automated actions that help a user to analyze and solve such errors, as discussed further below in conjunction with FIG. 8. The patch task execution process 330 performs a designated set of tasks in one or more selected servers before the patching starts, as discussed further below in conjunction with FIG. 9. The server jobs setup process 335 sets up and schedules scripts that will be executed during the patching process so that they can be executed in a timely manner during the patching process to aid with tracking and administration.

In one embodiment, a data processing phase 350 generates and processes data in order to generate one or more visualizations, as discussed further below in conjunction with FIGS. 10 and 11.

FIG. 4 is a flow diagram illustrating an exemplary implementation of a new server discovery process in accordance with an illustrative embodiment. The server discovery process allows one or more patching teams to be aware of the possible servers that are to be maintained and taken care of through the patching process. There may be several teams working within different product lines and sectors, and they often implement things differently. Thus, many different forms of servers may be presented for maintenance. The servers that execute in containers, for example, may not require patching.

Initially, one or more data sources are analyzed to identify new servers in a given domain. The data sources may comprise, for example, centralized company indexes that store information about deployed servers (e.g., in the form of company databases, such as SQL tables, and/or application programming interface (API) resources that allow the disclosed patching orchestration management techniques to access more specifically filtered servers through HTTP requests). One or more aspects of the disclosure recognize that the way that information is presented in company databases and/or API resources may not be the same. Thus, in some embodiments, the disclosed patching orchestration management techniques initially process the data from multiple data sources and make the data available in an internal relational database in order to proceed in a standardized manner.

One or more aspects of the disclosure recognize a possibility that one or more servers identified as being new in a company database and/or an API resource may already be tracked in the disclosed patching orchestration management tool at the time of the data pull (e.g., due to human and/or external system flaws regarding server tracking). Thus, after acquiring data from the company databases and/or API resources, the disclosed patching orchestration management techniques, in some embodiments, execute a verification process that compares the available data with data of the patching orchestration management tool. At first, the system determines whether a server is already known or new. If a server is already known, the disclosed new server discovery techniques rely on the existing information regarding the patching of the known server (and considers the presence of the server as being new in the company databases and/or API resources as an error). In this manner, the introduction of duplicated information in the system is prevented and filtered, thereby preventing data loss.

Thereafter, the system automatically verifies the remaining identified servers using, for example, two criteria. The operating system of each new server is evaluated to see, for example, if the server executes a Windows virtual machine (e.g., verifying the operating system of the server). In addition, each new server is evaluated to see whether the server hosts a database server (e.g., by verifying the allocated drive space of the server). These criteria allow the disclosed patching orchestration management techniques to focus on the servers that need to be patched (e.g., a Windows virtual machine server that hosts application servers) and to be aware of possible misclassifications that might come from external sources (that could potentially harm the system).

Thus, the disclosed patching orchestration techniques implement a resilient pre-verification of servers in order to prevent errors and to make it possible to manage hosts from several different sources.

In the example of FIG. 4, the new server discovery process accesses data from one or more external APIs 410 and/or one or more organization databases 420. The process initially determines whether a given server, identified using the external APIs 410 and/or the organization databases 420, is already known in step 430 (e.g., preexists in one or more patching orchestration management data records). Thereafter, the operating system and database evaluations discussed above are performed in step 440. The process of FIG. 4 generates a set of filtered data 450 comprising a set of discovered servers.

FIG. 5 is a flow diagram illustrating an exemplary implementation of a server classification process in accordance with an illustrative embodiment. The server classification process employs categories related to the patching management process. As the patching process may be long and complex with a large number of servers, it may be necessary to create different patch groups in order to more efficiently patch the servers over a period of time. The patch groups may be assigned based on time and may be divided over the hours of, for example, a two-day period when the patching process is performed. Servers may also be allocated into certain groups according to the applications served by the respective server. In the event that a given server is identified as no longer to be supported by the patching process, the given server may be assigned to a “No Action” group. Once the patching process occurs, this previous orchestration helps to ensure that things go smoothly without process overflows or disorganized and disorderly executions, such as patching servers regardless of their applications and thus causing possible service shortages.

In addition, certain servers may need to go through a markdown process comprising a temporary suspension of service in order to go through patching. Thus, it may be necessary for the operator to set one or more servers in a markdown group, for example. This classification precedes the patching execution and happens during the patching orchestration management phase. If these classification tasks were performed dynamically, during the patching itself, it could lead to delays and potential issues in the patching process, such as the crashing of scripts that must be performed.

In the example of FIG. 5, the server classification process processes unclassified server data 510 using one or more classification processes in step 530 and one or more designated classification categories 520, to generate classified server data 550. In step 530, the classification is performed automatically and may comprise identifying the application hosted by each server identified in the unclassified server data 510 and, according to the mapping of other servers that host the same application, classify the server in accordance with the pattern. In addition, the “Patching Group” and “To Markdown” attributes of a given server may also be set, creating a system that progressively and automatically classifies servers. If new groupings are required for the specific needs of the system, the classification process adds the new categories to the designated classification categories 520. In this manner, an associative model of classification is provided in some embodiments that prevents servers that are not identified with any application from joining the patching process.

The server classification process may allow operators to write notes that mark one or more servers needing special treatment during patching, considering specifications more generally. In this manner, unexpected exceptions can be prevented. In addition, the classification step can generate one or more automated notifications that help to formalize the requests for information from third-party contributors, for example.

FIG. 6 is a flow diagram illustrating an exemplary implementation of a server script installation process in accordance with an illustrative embodiment. The server script installation process installs one or more software scripts that allow the team to generate data and information for further patching orchestration analysis. As discussed further below in conjunction with FIG. 7, the installed software scripts monitor when a given server reboots, how the given server reacts to the patching process during execution and confirms if the patching of the given server went well (or if the given server faced any issues regarding the patching). The script installation reduces resource usage since it does not employ constant monitoring, and the information is generated in some embodiments only when the server reboots after the patching process completes. In some implementations, the server script installation process automatically installs the software scripts in several servers simultaneously (e.g., in parallel) using an internal tool interface.

In the example of FIG. 6, classified server data 610 (e.g., as generated by the server classification process of FIG. 5) is processed in step 630 to install one or more software scripts in servers, identified in the classified server data 610, to be patched.

FIG. 7 is a flow diagram illustrating an exemplary implementation of a server script execution process in accordance with an illustrative embodiment. In the example of FIG. 7, the server script execution process initiates upon completion of a server patch, as indicated, for example, by a server patch completion flag 710. When the server restarts in step 720, the one or more installed server scripts will be executed in step 730 and logs generated by the executed server scripts are collected in step 740. The collected log data is analyzed in step 750.

FIG. 8 is a flow diagram illustrating an exemplary implementation of a server health evaluation process in accordance with an illustrative embodiment. During the patching process, it is possible that one or more servers may display issues. In the example of FIG. 8, the server health evaluation process evaluates servers for the presence of one or more designated errors in step 810. For example, the designated errors may comprise a server not being reachable, issues with domain name system (DNS) information of a server, a server denying access to management accounts, insufficient storage space, remote procedure call (RPC) failures, Windows Management Instrumentation (WMI) failures and WSMan protocol errors. The monitoring results are stored in step 820, and one or more identified errors are automatically mitigated in step 830.

If a server is found to be not reachable in step 810 (e.g., the server cannot be pinged), one or more notifications may be generated in step 830 to engage the related teams that could be helpful in determining the root cause of the issue and fixing the issue. If the DNS information of a server is found in step 810 to be incompatible with its complete FQDN (fully qualified domain name) address (i.e., there is a distinction between the registered FQDN address and the result of the combination of a servers network name and their domain address), this could lead to issues regarding reaching out the server to perform patching actions, since the internal patching functionalities use the FQDN address in order to find the servers. If there are one or more issues with the server DNS, then one or more notifications to a team that manages the DNS addresses may be automatically generated in step 830.

It is important that servers to be patched allow access to the administrator accounts that are used by scripts that are run or by operators who are analyzing and performing steps of the patching process manually. If a server is found to deny access to management accounts in step 810, it may prevent the patching from being performed. If a server is found to have such an access failure, step 830 may evaluate whether the server is added to the appropriate permission group of the manager's permissions or else one or more notifications may be automatically generated to achieve the addition.

The patching process requires free disk space in the servers to be patched in order to install, for example, updates and necessary packages and to perform system changes. When there is insufficient disk space (e.g., a minimum of 6 GB of free disk space), the process could present several failures. If a server is found to have insufficient disk space in step 810, a clean-up script may be executed for the server in step 830 and if this does not free enough disk space to solve the problem, more disk space may be automatically requested.

RPC failures may prevent the disclosed patching orchestration management techniques from connecting to the server and from collecting data from the server. If a given server is found to have RPC failures in step 810, the status of the given server may be evaluated in the system. If the server is not running, the start button may be activated.

The installed scripts, in some embodiments, utilize WMI in order to acquire system information and, at times, to perform actions in the servers during the patching orchestration. If the server health evaluation process determines that WMI is not responding, a script can be executed that tries to get WMI objects from a remote computer with appropriate permissions. If the server fails this second test, then one or more notifications may be automatically generated in step 830.

WSMan is a protocol by which actions in Windows remote servers can be ordered. The WSMan protocol can be used by scripts and/or operators that want to perform actions in other remote servers. If the server health evaluation process determines that the WSMan protocol is not responding, a script can be executed that reevaluates the WSMan protocol. If the server fails this second test, then one or more notifications to firewall and/or networking teams, for example, may be automatically generated in step 830 to address a misconfiguration of these elements that might be causing the issues with the server.

In some embodiments, the evaluations performed in step 810 are classified into two groups, A first group may be evaluated on a regular (e.g., daily) basis and generates daily information for the patch orchestrators. A second group may be evaluated according to a schedule, which generates information only in scheduled periods. Scheduled jobs may run during the patching process itself, for example, during which they collect information and send relevant notifications to the patching orchestrators.

The server health evaluation process of FIG. 8 may analyze the identified servers, categorize the identified servers into one or more different error groups that can cause problems during the patching processes and/or perform one or more automated actions that help a user to analyze and solve such errors, such as the automated actions described above and other automated actions.

FIG. 9 is a flow diagram illustrating an exemplary implementation of a patch task execution process in accordance with an illustrative embodiment. In the example of FIG. 9, the patch task execution process executes one or more designated patch tasks on one or more servers in step 910. The task execution results may be stored in step 920, and one or more identified task execution issues may be automatically mitigated in step 930. For example, the executed patch tasks may evaluate for the following task execution issues: blank host name, blank group, Linux host classification, non-production or decommissioned servers, deviating host names, database server classification and server status change.

A recently discovered server may lack an appropriate host name indicating their FQDN address. In order to accomplish internal standards for the patching orchestration process, in some embodiments, all servers must possess this information, thus, one of the necessary patch tasks may be to treat such examples as they appear in the patching orchestration management data pool. As noted above, during the classification step, servers may be classified according to their respective patching groups. However, there are situations (especially when servers are being decommissioned and patching orchestration shall no longer be supported) where operators or system functions set their group as blank without directly pointing out the decommissioning. Thus, during the patching orchestration, it may be necessary to treat all such cases, so that during the patching process all supported servers are allocated in their appropriate groups.

In addition, Linux hosts that eventually reach the process through the analysis of new servers in the domain are classified as such, since their verifications can differ from the verifications performed on Windows virtual machines, for example. Thus, during the orchestration, possible Linux hosts may be analyzed and, if necessary, marked as such (and will typically be ignored for patching). The patching orchestration management, in some embodiments, assumes that the servers being patched will all belong to a particular domain. In practice, the patching may be performed only against production servers. Thus, during the search of new servers, the system may detect one or more non-production servers by analyzing their characteristics, such as their domain name. Thus, the system may regard such servers as potential non-production servers, which may be further analyzed and, if necessary, removed from the patching treatment data pool.

Similarly, servers that were previously supported by the patching process may no longer be considered assets to be administrated for patching, due to, for example, product replacement, server transfer and/or update. Thus, when a server is decommissioned and marked as such, the decommissioned server is no longer placed in a patching group. However, during the orchestration phase, it is often necessary to analyze servers that were set as decommissioned due to the possibility that it was only temporary or that they were servers that were previously disconnected but are making a comeback. In these situations, during the orchestration management, the orchestrator may evaluate the server conditions and act accordingly.

Host names (e.g., FQDN addresses) must typically comply with regulatory standards and/or policies of an organization. Thus, when the addresses of such servers seem incorrect or non-compliant, it may be necessary to analyze them further. There are cases when servers have been wrongly addressed and thus need a change. However, there are other cases where servers just have unusual or atypical names. In these cases, the server names are to be confirmed as valid.

Database servers typically do not behave in the same manner as application servers. In addition, database servers may not undergo the regular patching process that is destined and adapted to application servers. However, especially regarding “young” database servers, database servers are not always marked as such during the server discovery phase. When database servers display database-like characteristics, they are then displayed as database servers during the orchestration process so that further analysis can be done and if necessary, they can be marked properly.

If, during the patching orchestration process, the availability status of a server changes and that is then informed to a patching orchestration management team, the server may be reassessed in order to better classify the server and define the server's adequate treatment and classification. In this manner, in one or more embodiments, the disclosed patching orchestration management techniques perform preventive and corrective treatment of such conditions (e.g., during the patch preprocessing).

FIG. 10 is a sample table illustrating a server change history in accordance with an illustrative embodiment. In some embodiments, each change that happens to attributes of a server in an orchestration database is recorded in a log. In the example of FIG. 10, for each server attribute change event, the date and time of the server attribute change event are indicated, the server identifier and the attribute name associated with the modification are indicated, as well as the prior attribute value and the new attribute value.

During the patching orchestration management process, an operator is able to see these server attribute change events in a temporal order, and to filter the events by server or by type of change, for example. One or more aspects of the disclosure recognize that it is beneficial to be able to analyze the server attribute change events and to track these changes in order to identify unexpected developments, positive changes and errors, for example. Furthermore, this history may be used for further data analysis since it can provide the result of searches in a designated format, such as a CSV (comma separated value) model, which can then be further manipulated by the patching orchestration operator as necessary.

FIG. 11 is a sample table illustrating a process events history in accordance with an illustrative embodiment. While the server change history of FIG. 10 focuses on the individual changes that happen to server attributes, the process events history focuses on events that happen during a patching cycle and that are described by the server health, patch tasks and patching cycle action categories. While such events also happen to servers, the events are not necessarily related to changes in attribute values, but more generally to processes that they go through during the patching orchestration. For example, if a given server is discovered during the new server discovery phase, classified as being faulty regarding the disk space and analyzed regarding whether or not the given server is a non-production server, these events are stored and accessible through the visualization of FIG. 11. In this manner, operators can generate and track important business metrics and understand patterns in events, in order to fix problems that can only be found through an analysis over time and to change the orchestration process, if necessary, for the orchestration process to improve. Thus, the view of FIG. 11 provides a key to process improvement.

In the example of FIG. 11, for each process event, the server identifier, host name, application, site identifier and group associated with the process event are indicated.

In addition, an executive summary visualization can be provided in some embodiments to act as a bridge between an orchestration team and an executive team. After a patching cycle is finished, the executive summary visualization can return relevant data for analysis by executives. This data may be collected when the patching cycle completes, and thus, because it can be analyzed prior to, or during, the orchestration of the next patching cycle, it is related to the orchestration management process. The data presented in the executive summary visualization may comprise, for example: services that failed to run properly after the patching execution; services that were successfully restarted by custom scripts; servers checked manually during the orchestration process; total number of servers that passed post-patching validations; total number of servers that went through post-patching validations; servers marked up and/or down; and servers that went through a data center load balancing process.

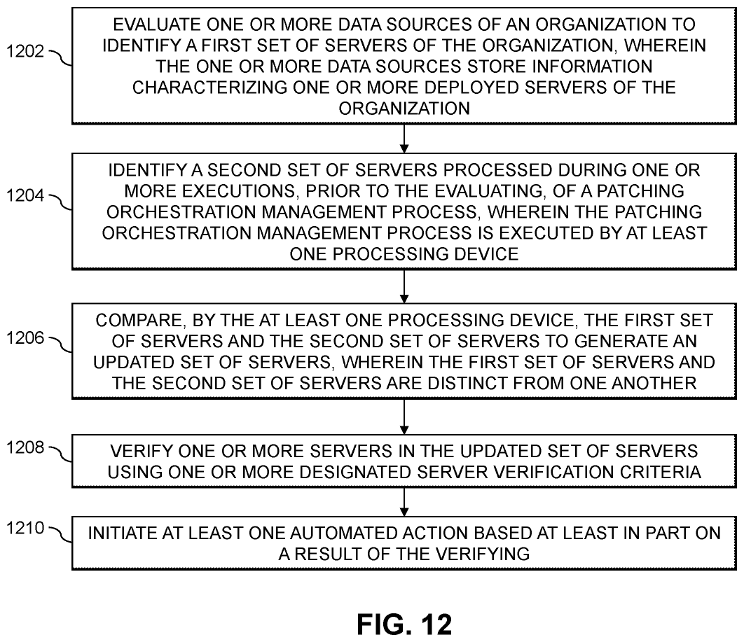

FIG. 12 is a flow diagram illustrating an exemplary implementation of a method for patching orchestration management using verification of identified servers, according to one or more embodiments of the disclosure. In the example of FIG. 12, one or more data sources of an organization are evaluated to identify a first set of servers of the organization, wherein the one or more data sources store information characterizing one or more deployed servers of the organization in step 1202.

In step 1204, a second set of servers processed during one or more executions, prior to the evaluating, of a patching orchestration management process is identified, wherein the patching orchestration management process is executed by at least one processing device. The first set of servers and the second set of servers are compared in step 1206 to generate an updated set of servers, wherein the first set of servers and the second set of servers are distinct from one another. One or more servers in the updated set of servers are verified in step 1208 using one or more designated server verification criteria. At least one automated action is initiated in step 1210 based at least in part on a result of the verifying.

In one or more embodiments, the one or more designated server verification criteria comprise one or more of identifying an operating system of one or more servers in the updated set of servers and evaluating one or more storage resources of one or more servers in the updated set of servers. One or more applications executed by respective ones of the servers in the updated set of servers may be identified and may be classified, based on the identified one or more applications, into: (i) a first group of servers used to schedule a patching of one or more of the servers in the first group of servers and/or (ii) a second group of servers comprising one or more servers requiring a temporary suspension of service during an execution of a patching process directed to one or more of the servers in the second group of servers.

In some embodiments, one or more monitoring software programs are automatically installed in respective ones of the servers in the updated set of servers, wherein, in response to a rebooting of a given server, following a patching of the given server, a corresponding one of the installed monitoring software programs provides data from an operation of the given server. In addition, one or more of the servers in the updated set of servers may be automatically evaluated with respect to one or more designated server error conditions and one or more server error conditions identified by the automatic evaluation of the one or more designated server error conditions may be automatically mitigated using one or more designated error resolutions.

In at least one embodiment, one or more designated patch tasks may be automatically performed for one or more of the servers in the updated set of servers and one or more issues identified by the one or more designated patch tasks may be automatically mitigated using one or more designated patch task resolutions. The comparing the first set of servers and the second set of servers may comprise removing one or more servers identified in the first set of servers from the second set of servers to generate the updated set of servers.

In an embodiment, data may be automatically visualized characterizing one or more changes to one or more attributes of one or more of the servers in the updated set of servers and/or one or more events occurring with respect to one or more of the servers in the updated set of servers. The at least one automated action may comprise processing one or more of the servers in the updated set of servers as part of an execution of the patching orchestration management process.

In some embodiments, the automated actions may comprise automatically evaluating at least one server in the updated set of servers with respect to designated server error conditions and automatically mitigating one or more server error conditions identified by the automatic evaluation of the designated server error conditions using one or more designated error resolutions. In an embodiment, the automated actions may comprise automatically performing designated patch tasks for at least one server in the updated set of servers and automatically mitigating any issues identified by the designated patch tasks using designated patch task resolutions. In addition, data characterizing changes to attributes of the servers in the updated set of servers and/or events occurring with respect to any servers in the updated set of servers may be automatically visualized or included in automated notifications or alerts.

The particular processing operations and other network functionality described in conjunction with the flow diagrams of FIGS. 3 through 12 are presented by way of illustrative example only and should not be construed as limiting the scope of the disclosure in any way. Alternative embodiments can use other types of processing operations for patching orchestration management using verification of identified servers. For example, the ordering of the process steps may be varied in other embodiments, or certain steps may be performed concurrently with one another rather than serially. In one aspect, the process can skip one or more of the steps. In other aspects, one or more of the steps are performed simultaneously. The processing of one or more of the steps can also be distributed between multiple components. In some aspects, additional steps can be performed.

In some embodiments, techniques are provided for patching orchestration management using verification of identified servers. In at least some embodiments, the disclosed patching orchestration management techniques improve reliability and consistency, and reduce the time and amount of resources needed to prepare for a patching process.

One or more embodiments of the disclosure provide improved methods, apparatus and computer program products for patching orchestration management using verification of identified servers. The foregoing applications and associated embodiments should be considered as illustrative only, and numerous other embodiments can be configured using the techniques disclosed herein, in a wide variety of different applications.

It should also be understood that the disclosed patching orchestration management techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for patching orchestration management using verification of identified servers may be implemented using one or more processing platforms. One or more of the processing modules or other components may therefore each execute on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that executes on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based patching orchestration management processing engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based patching orchestration management processing platform in illustrative embodiments. The cloud-based systems can include block storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may execute on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

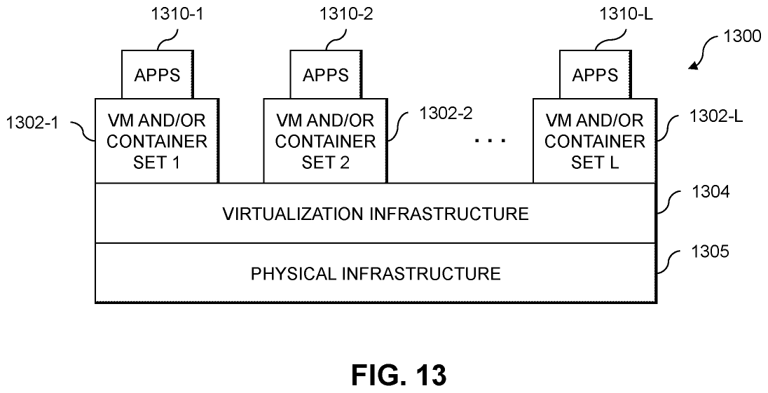

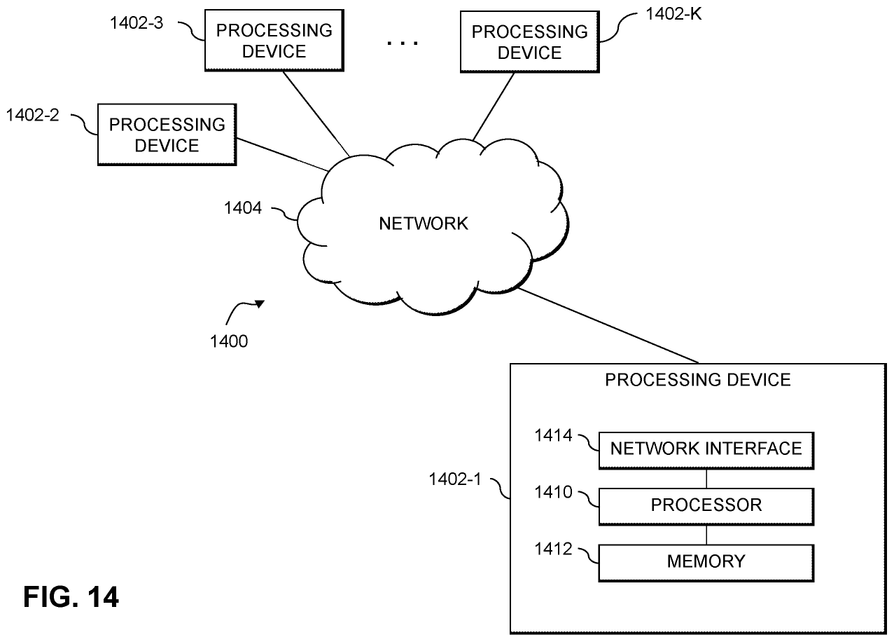

Illustrative embodiments of processing platforms will now be described in greater detail with reference to FIGS. 13 and 14. These platforms may also be used to implement at least portions of other information processing systems in other embodiments.

FIG. 13 shows an example processing platform comprising cloud infrastructure 1300. The cloud infrastructure 1300 comprises a combination of physical and virtual processing resources that may be utilized to implement at least a portion of an information processing system. The cloud infrastructure 1300 comprises multiple virtual machines (VMs) and/or container sets 1302-1, 1302-2, . . . 1302-L implemented using virtualization infrastructure 1304. The virtualization infrastructure 1304 executes on physical infrastructure 1305, and illustratively comprises one or more hypervisors and/or operating system level virtualization infrastructure. The operating system level virtualization infrastructure illustratively comprises kernel control groups of a Linux operating system or other type of operating system.

The cloud infrastructure 1300 further comprises sets of applications 1310-1, 1310-2, . . . 1310-L running on respective ones of the VMs/container sets 1302-1, 1302-2, . . . 1302-L under the control of the virtualization infrastructure 1304. The VMs/container sets 1302 may comprise respective VMs, respective sets of one or more containers, or respective sets of one or more containers running in VMs.

In some implementations of the FIG. 13 embodiment, the VMs/container sets 1302 comprise respective VMs implemented using virtualization infrastructure 1304 that comprises at least one hypervisor. Such implementations can provide patching orchestration management functionality of the type described above for one or more processes running on a given one of the VMs. For example, each of the VMs can implement patching orchestration management control logic and associated functionality for preparing one or more servers for a patching process.

An example of a hypervisor platform that may be used to implement a hypervisor within the virtualization infrastructure 1304 is a compute virtualization platform which may have an associated virtual infrastructure management system such as server management software. The underlying physical machines may comprise one or more distributed processing platforms that include one or more storage systems.

In other implementations of the FIG. 13 embodiment, the VMs/container sets 1302 comprise respective containers implemented using virtualization infrastructure 1304 that provides operating system level virtualization functionality, such as support for Docker containers running on bare metal hosts, or Docker containers running on VMs. The containers are illustratively implemented using respective kernel control groups of the operating system. Such implementations can provide patching orchestration management functionality of the type described above for one or more processes running on different ones of the containers. For example, a container host device supporting multiple containers of one or more container sets can implement one or more instances of patching orchestration management control logic and associated functionality for preparing one or more servers for a patching process.

As is apparent from the above, one or more of the processing modules or other components of the information processing system may each execute on a computer, server, storage device or other processing platform element. A given such element may be viewed as an example of what is more generally referred to herein as a processing device. The cloud infrastructure 1300 shown in FIG. 13 may represent at least a portion of one processing platform. Another example of such a processing platform is processing platform 1400 shown in FIG. 14.

The processing platform 1400 in this embodiment comprises at least a portion of the given system and includes a plurality of processing devices, denoted 1402-1, 1402-2, 1402-3, . . . 1402-K, which communicate with one another over a network 1404. The network 1404 may comprise any type of network, such as a WAN, a LAN, a satellite network, a telephone or cable network, a cellular network, a wireless network such as WiFi or WiMAX, or various portions or combinations of these and other types of networks.

The processing device 1402-1 in the processing platform 1400 comprises a processor 1410 coupled to a memory 1412. The processor 1410 may comprise a microprocessor, a microcontroller, an application specific integrated circuit (ASIC), a field programmable gate array (FPGA) or other type of processing circuitry, as well as portions or combinations of such circuitry elements, and the memory 1412, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1402-1 is network interface circuitry 1414, which is used to interface the processing device with the network 1404 and other system components, and may comprise conventional transceivers.

The other processing devices 1402 of the processing platform 1400 are assumed to be configured in a manner similar to that shown for processing device 1402-1 in the figure.

Again, the particular processing platform 1400 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 13 or 14, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
evaluating one or more data sources of an organization to identify a first set of servers of the organization, wherein the one or more data sources store information characterizing one or more deployed servers of the organization;
identifying a second set of servers processed during one or more executions, prior to the evaluating, of a patching orchestration management process, wherein the patching orchestration management process is executed by at least one processing device;
comparing, by the at least one processing device, the first set of servers and the second set of servers to generate an updated set of servers, wherein the first set of servers and the second set of servers are distinct from one another;
verifying one or more servers in the updated set of servers using one or more designated server verification criteria; and
initiating at least one automated action based at least in part on a result of the verifying;
wherein the at least one processing device comprises a processor coupled to a memory.

2. The method of claim 1, wherein the one or more designated server verification criteria comprise one or more of identifying an operating system of one or more servers in the updated set of servers and evaluating one or more storage resources of one or more servers in the updated set of servers.

3. The method of claim 1, further comprising identifying one or more applications executed by respective ones of the servers in the updated set of servers and classifying, based on the identified one or more applications, one or more of the servers in the updated set of servers into one or more of: (i) a first group of servers used to schedule a patching of one or more of the servers in the first group of servers and (ii) a second group of servers comprising one or more servers requiring a temporary suspension of service during an execution of a patching process directed to one or more of the servers in the second group of servers.

4. The method of claim 1, further comprising automatically installing one or more monitoring software programs in one or more of the servers in the updated set of servers, wherein, in response to a rebooting of a given server, following a patching of the given server, at least one of the one or more monitoring software programs installed in the given server provides data from an operation of the given server.

5. The method of claim 1, further comprising (i) automatically evaluating one or more of the servers in the updated set of servers with respect to one or more designated server error conditions and (ii) automatically mitigating one or more server error conditions identified by the automatic evaluation of the one or more designated server error conditions using one or more designated error resolutions.

6. The method of claim 1, further comprising (i) automatically performing one or more designated patch tasks for one or more of the servers in the updated set of servers and (ii) automatically mitigating one or more issues identified by the one or more designated patch tasks using one or more designated patch task resolutions.

7. The method of claim 1, further comprising automatically visualizing data characterizing one or more of: (i) one or more changes to one or more attributes of one or more of the servers in the updated set of servers and (ii) one or more events occurring with respect to one or more of the servers in the updated set of servers.

8. The method of claim 1, wherein the at least one automated action comprises processing one or more of the servers in the updated set of servers as part of an execution of the patching orchestration management process.

9. The method of claim 1, wherein the comparing the first set of servers and the second set of servers comprises removing one or more servers identified in the first set of servers from the second set of servers to generate the updated set of servers.

10. An apparatus comprising:
at least one processing device comprising a processor coupled to a memory;
the at least one processing device being configured to implement the following steps:
evaluating one or more data sources of an organization to identify a first set of servers of the organization, wherein the one or more data sources store information characterizing one or more deployed servers of the organization;
identifying a second set of servers processed during one or more executions, prior to the evaluating, of a patching orchestration management process, wherein the patching orchestration management process is executed by the at least one processing device;
comparing, by the at least one processing device, the first set of servers and the second set of servers to generate an updated set of servers;
verifying one or more servers in the updated set of servers using one or more designated server verification criteria; and
initiating at least one automated action based at least in part on a result of the verifying.

11. The apparatus of claim 10, wherein the one or more designated server verification criteria comprise one or more of identifying an operating system of one or more servers in the updated set of servers and evaluating one or more storage resources of one or more servers in the updated set of servers.

12. The apparatus of claim 10, further comprising identifying one or more applications executed by respective ones of the servers in the updated set of servers and classifying, based on the identified one or more applications, one or more of the servers in the updated set of servers into one or more of: (i) a first group of servers used to schedule a patching of one or more of the servers in the first group of servers and (ii) a second group of servers comprising one or more servers requiring a temporary suspension of service during an execution of a patching process directed to one or more of the servers in the second group of servers.

13. The apparatus of claim 10, further comprising automatically installing one or more monitoring software programs in one or more of the servers in the updated set of servers, wherein, in response to a rebooting of a given server, following a patching of the given server, at least one of the one or more monitoring software programs installed in the given server provides data from an operation of the given server.

14. The apparatus of claim 10, further comprising (i) automatically evaluating one or more of the servers in the updated set of servers with respect to one or more designated server error conditions and (ii) automatically mitigating one or more server error conditions identified by the automatic evaluation of the one or more designated server error conditions using one or more designated error resolutions.

15. The apparatus of claim 10, further comprising (i) automatically performing one or more designated patch tasks for one or more of the servers in the updated set of servers and (ii) automatically mitigating one or more issues identified by the one or more designated patch tasks using one or more designated patch task resolutions.

16. A non-transitory processor-readable storage medium having stored therein program code of one or more software programs, wherein the program code when executed by at least one processing device causes the at least one processing device to perform the following steps:
evaluating one or more data sources of an organization to identify a first set of servers of the organization, wherein the one or more data sources store information characterizing one or more deployed servers of the organization;
identifying a second set of servers processed during one or more executions, prior to the evaluating, of a patching orchestration management process, wherein the patching orchestration management process is executed by the at least one processing device;
comparing, by the at least one processing device, the first set of servers and the second set of servers to generate an updated set of servers;
verifying one or more servers in the updated set of servers using one or more designated server verification criteria; and
initiating at least one automated action based at least in part on a result of the verifying.

17. The non-transitory processor-readable storage medium of claim 16, further comprising identifying one or more applications executed by respective ones of the servers in the updated set of servers and classifying, based on the identified one or more applications, one or more of the servers in the updated set of servers into one or more of: (i) a first group of servers used to schedule a patching of one or more of the servers in the first group of servers and (ii) a second group of servers comprising one or more servers requiring a temporary suspension of service during an execution of a patching process directed to one or more of the servers in the second group of servers.

18. The non-transitory processor-readable storage medium of claim 16, further comprising automatically installing one or more monitoring software programs in one or more of the servers in the updated set of servers, wherein, in response to a rebooting of a given server, following a patching of the given server, at least one of the one or more monitoring software programs installed in the given server provides data from an operation of the given server.

19. The non-transitory processor-readable storage medium of claim 16, further comprising (i) automatically evaluating one or more of the servers in the updated set of servers with respect to one or more designated server error conditions and (ii) automatically mitigating one or more server error conditions identified by the automatic evaluation of the one or more designated server error conditions using one or more designated error resolutions.

20. The non-transitory processor-readable storage medium of claim 16, further comprising (i) automatically performing one or more designated patch tasks for one or more of the servers in the updated set of servers and (ii) automatically mitigating one or more issues identified by the one or more designated patch tasks using one or more designated patch task resolutions.
